(19) United States
(12) Patent Application Publication
(10) Pub. No.: US 2025/0102662 A1
(43) Pub. Date: Mar. 27, 2025

(54) METHOD AND APPARATUS FOR REFERENCE SIGNAL CONFIGURATION IN WIRELESS COMMUNICATION SYSTEM

(71) Applicant: SAMSUNG ELECTRONICS CO., LTD., Suwon-si (KR)

(72) Inventors: Xingyu HAN, Beijing (CN); Hong WANG, Beijing (CN)

(21) Appl. No.: 18/898,456

(22) Filed: Sep. 26, 2024

(30) Foreign Application Priority Data
Sep. 26, 2023 (CN) 202311257731.X

(51) Int. Cl. G01S 13/76; H04L 5/00

(52) U.S. Cl. CPC G01S 13/765; H04L 5/0032; H04L 5/0048

(57) ABSTRACT

The disclosure relates to a 5G or 6G communication system for supporting a higher data transmission rate. The present disclosure provides a method performed by location management function (LMF) in a communication system, the method comprising: transmitting, to a serving base station, a first request message for an area-specific reference signal configuration; and receiving, from the serving base station, a first response message including reference signal configuration information; wherein the reference signal configuration information includes: at least one reference signal configuration and validity area related information corresponding to the reference signal configuration.

### CROSS-REFERENCE TO RELATED APPLICATION

This application is based on and claims priority under 35 U.S.C. § 119 to Chinese Patent Application No. 202311257731.X filed on Sep. 26, 2023, in the Chinese Intellectual Property Office, the disclosure of which is incorporated by reference herein in its entirety.

### BACKGROUND

### 1. Field

The present disclosure relates to the field of communication, and more particularly, to method and apparatus for reference signal configuration in wireless communication system.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### SUMMARY

According to an aspect of the present disclosure, there is provided a method performed by location management function (LMF) in a communication system, the method comprising: transmitting, to a serving base station, a first request message for an area-specific reference signal configuration information; and receiving, from the serving base station, a first response message including reference signal configuration information; wherein the reference signal configuration information includes: at least one reference signal configuration and validity area related information corresponding to the reference signal configuration;

According to the method performed by the location management function (LMF) in a communication system according to the present disclosure, wherein the method further comprises: wherein the method further comprises: transmitting, to the serving base station, a second request message for requesting information related to available reference signal resources; and receiving, from the serving base station, a second response message; wherein the second request message includes at least one of the following: a reference signal resource request; a reference signal resource time window request; a cell related identification; and a first cell related identification list; wherein the second response message includes at least one of: a cell related identification; a second cell related identification list; reference signal resource related information; a reference signal resource related information list; time window related information; and a time window related information list.

According to the method performed by the location management function (LMF) in a communication system according to the present disclosure, wherein the method further comprises: transmitting, to a neighboring base station, a third request message for requesting information related to reserved reference signal configuration; and receiving, from the third neighboring base station, a third response message; wherein the third request message includes at least one of the following: a reference signal configuration reservation request; requested reserved reference signal configuration related information; and user equipment identification related information; wherein the third response information includes at least one of: an indication of accepting or rejecting to reserve for the reference signal configuration; an indication of successful or unsuccessful reservation of the reference signal configuration; related information of accepting or successfully reserving for the reference signal configuration; a related information list of accepting or successfully reserving for the reference signal configuration; related information of rejecting or unsuccessfully reserving for the reference signal configuration; and a related information list of rejecting or unsuccessfully reserving for the reference signal configuration.

According to an aspect of the present disclosure, there is provided a method performed by a serving base station in a communication system, the method comprising: receiving, from location management function (LMF), a first request message for an area-specific reference signal configuration information; and sending transmitting, to the LMF, a first response message including reference signal configuration information; wherein the reference signal configuration information includes: at least one reference signal configuration and validity area related information corresponding to the reference signal configuration.

According to the method performed by the serving base station in a communication system according to the present disclosure, wherein the method further comprises: transmitting, to a distribution unit of the serving base station, a second request message for an area-specific reference signal configuration; and receiving, from the distribution unit of the serving base station, a second response message including the reference signal configuration information; wherein the reference signal configuration information includes: at least one reference signal configuration and validity area related information corresponding to the reference signal configuration; and user equipment identification related information.

According to the method performed by the serving base station in a communication system according to the present disclosure, wherein the method further comprises: receiving, from the LMF, second information including validity area related information; and generating first updated validity area related information based on the validity area related information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. For example, “at least one of A, B, or C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The terms used herein to describe the embodiments of the present application is not intended to limit and/or define the scope of the present application. For example, unless otherwise defined, the technical or scientific terms used in the present disclosure should have ordinary meanings as understood by ordinary skilled in the art to which the present application belongs.

It should be understood that “first”, “second” and similar words used in the present disclosure do not indicate any order, quantity or importance, but are only used to distinguish different components. Unless clearly indicated otherwise in the context, similar words such as “a”, “an”, “the” and the like in the singular form do not indicate a quantitative limitation, but indicate the existence of at least one.

As used herein, any reference to “one example” or “an example”, “one embodiment” or “an embodiment” means that a particular element, feature, structure or characteristic described in conjunction with the embodiment is included in at least one embodiment. The appearances of the phrases “in one embodiment” or “in one example” in different places in the specification are not necessarily all referring to the same embodiment.

As used herein, “a part of” a certain thing means “at least some of” this thing, so it may mean being less than the entirety thereof or being the entirety thereof. Therefore, “a part of” the thing includes the whole thing as a special case, that is, an example in which the whole thing is a part of the thing.

It will be further understood that words such as “include”, “contain” or the like means that the elements or objects appearing preceding the word encompass the elements or objects listed behind the word as well as their equivalents, without excluding other elements or objects. Words such as “connect”, “interconnect” or the like are not limited to physical or mechanical connections, but may include electrical connection, whether direct or indirect. “Up”, “Down”, “Left” and “Right” are only used to indicate relative positional relationships. When the absolute position of the described object changes, accordingly, the relative positional relationship may change as well.

The various embodiments discussed below for describing the principle of the present disclosure in this patent document are for illustration only, and should not be construed as limiting the scope of the present disclosure in any way. Those skilled in the art will understand that the principle of the present disclosure may be implemented in any suitably arranged wireless communication system. For example, although the following detailed description of the embodiments of the present disclosure will focus on LTE and 5G communication systems, those skilled in the art can understand that the main points of the present disclosure can also be applied to other communication systems with similar technical backgrounds and channel formats, with slight modifications and basically without departing from the scope of the present disclosure. The schemes of the embodiments of the present application may be applied to various communication systems. For example, the communication systems may include a Global System for Mobile communications (GSM) system, a Code Division Multiple Access (CDMA) system, a Wideband Code Division Multiple Access (WCDMA) system, General Packet Radio Service (GPRS), Long Term Evolution (LTE) system, LTE Frequency Division DUplex (FDD) system, LTE Time Division DUplex (TDD), Universal Mobile Telecommunication System (UMTS), worldwide interoperability for microwave access (WiMAX) communication system, fifth generation (5th generation, 5G) system or New Radio (NR), etc. In addition, the schemes of the embodiments of the present application may be applied to future-oriented communication technologies. In addition, the schemes of the embodiments of the present application may be applied to future-oriented communication technologies.

The following description with reference to the accompanying drawings is provided to assist in a comprehensive understanding of various embodiments of the present disclosure as defined by the claims and their equivalents. The description includes various specific details to assist in that understanding but should be regarded as exemplary only. Accordingly, the ordinary skilled in the art will recognize that various changes and modifications to the various embodiments described herein can be made without departing from the scope and spirit of the present disclosure. In addition, descriptions of well-known functions and structures may be omitted for clarity and conciseness.

The terms and wordings used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only, but not for the purpose of limiting the present disclosure as defined by the appended claims and their equivalents.

It should be understood that the singular forms “a,” “an,” and “the” include plural referents, unless clearly indicated otherwise in the context. Thus, for example, reference to “a component surface” includes reference to one or more of such surfaces.

The term “include” or “may include” refers to the existence of a corresponding disclosed function, operation or component which can be used in various embodiments of the present disclosure, and does not limit the existence of one or more additional functions, operations, or components. The terms “include” and/or “have” may be construed to represent certain characteristics, numbers, steps, operations, constituent elements, components or combinations thereof, but may not be construed to exclude the possibility of existence of one or more other characteristics, numbers, steps, operations, constituent elements, components or combinations thereof.

The term “or” used in various embodiments of the present disclosure includes any of the listed terms or all combinations thereof. For example, “A or B” may include A, may include B, or may include both A and B.

Unless defined differently, all terms used in the present disclosure, including technical or scientific terms, have the same meanings as those understood by the skilled in the art as described in the present disclosure. Common terms as defined in a dictionary are to be interpreted to have meanings consistent with the context in the relevant technical field o, and are not to be interpreted ideally or excessively, unless clearly defined as such in the present disclosure.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1 illustrates a system architecture of System Architecture Evolution (SAE).

FIG. 2 illustrates a system architecture according to various embodiments of the present disclosure.

FIGS. 3A-3C illustrate an architecture of a base station according to various embodiments of the present disclosure.

FIG. 4A illustrates an interactive diagram of a method of inter-cell reference signal and/or related information configuration according to various embodiments of the present disclosure.

FIG. 4B illustrates an interactive diagram of a method of inter-cell reference signal and/or related information configuration activation according to various embodiments of the present disclosure.

FIG. 5 illustrates a block diagram of a network node according to an embodiment of the present disclosure.

FIG. 6 illustrates a block diagram of a user equipment according to an embodiment of the present disclosure.

### DETAILED DESCRIPTION

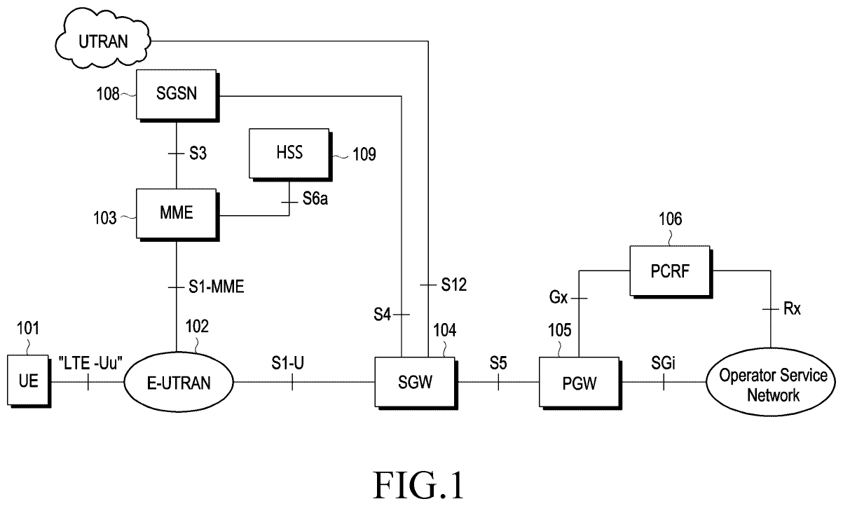

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In order to meet the objectives, technical schemes, and advantages of the embodiments of the present disclosure, a clear and complete description will be made with respect to the technical schemes of the embodiments of the present disclosure, in conjunction with the accompanying drawings of the embodiments of the present disclosure. Apparently, the described embodiments are a part of the embodiments of the present disclosure, not all of the embodiments. Based on the described embodiments of the present disclosure, all other embodiments obtained by ordinary skilled in the art without creative labor belong to the protection scope of the present disclosure.

FIG. 1 illustrates a system architecture 100 of system architecture evolution (SAE). User equipment (UE) 101 is a terminal device for receiving data. Evolved Universal Terrestrial Radio Access Network (E-UTRAN) 102 is a radio access network, which includes Hong Jizhan (eNOBE/Node B) which provides an interface for UE to access the radio network. The mobility management entity (MME) 103 is responsible for managing the mobility context, session context and security information of the UE. The serving gateway (SGW) 104 mainly provides the function of the user plane, and the MME 103 and SGW 104 may be in the same physical entity. The packet data network gateway (PGW) 105 is responsible for accounting, lawful interception and other functions, and may also be in the same physical entity as the SGW 104. A policy and charging rules function (PCRF) 106 provides quality of service (QOS) policies and charging criteria. The General Packet Radio Service Support Node (SGSN) 108 is a network node device that provides a route for data transmission in universal mobile telecommunications system (UMTS). Home subscriber server (HSS) 109 is the home attribution subsystem of the UE, and is responsible for protecting user information including the current location of the user equipment, the address of the service node, user security information, packet data context of the user equipment, etc.

FIG. 1 illustrates a system architecture 100 of system architecture evolution (SAE). User equipment (UE) 101 is a terminal device for receiving data. Evolved Universal Terrestrial Radio Access Network (E-UTRAN) 102 is a radio access network, which includes Hong Jizhan (eNOBE/Node B) which provides an interface for UE to access the radio network. The mobility management entity (MME) 103 is responsible for managing the mobility context, session context and security information of the UE. The serving gateway (SGW) 104 mainly provides the function of the user plane, and the MME 103 and SGW 104 may be in the same physical entity. The packet data network gateway (PGW) 105 is responsible for accounting, lawful interception and other functions, and may also be in the same physical entity as the SGW 104. A policy and charging rules function (PCRF) 106 provides quality of service (QOS) policies and charging criteria. The General Packet Radio Service Support Node (SGSN) 108 is a network node device that provides a route for data transmission in universal mobile telecommunications system (UMTS). Home subscriber server (HSS) 109 is the home attribution subsystem of the UE, and is responsible for protecting user information including the current location of the user equipment, the address of the service node, user security information, packet data context of the user equipment, etc.

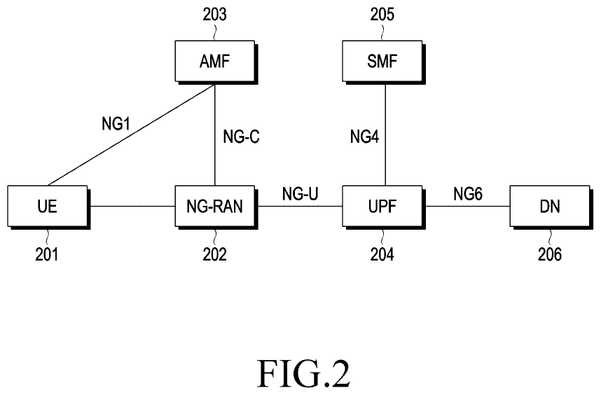

FIG. 2 illustrates a system architecture 200 according to various embodiments of the present disclosure. Other embodiments of the system architecture 200 can be used without departing from the scope of this disclosure.

User equipment (UE) 201 is a terminal device for receiving data. The next generation radio access network (ng-RAN) 202 is a radio access network, which includes a base station (gNB or an eNB connected to the 5GC of the 5G core network, and the eNB connected to the 5GC is also called ng-gNB) that provides an interface for UE to access the radio network. The access control and mobility management function (AMF) 203 is responsible for managing the mobility context and security information of the UE. The user plane function entity (UPF) 204 mainly provides the functions of the user plane. The session management functional entity SMF 205 is responsible for session management. The data network (DN) 206 includes services of operators, Internet access and services of third parties.

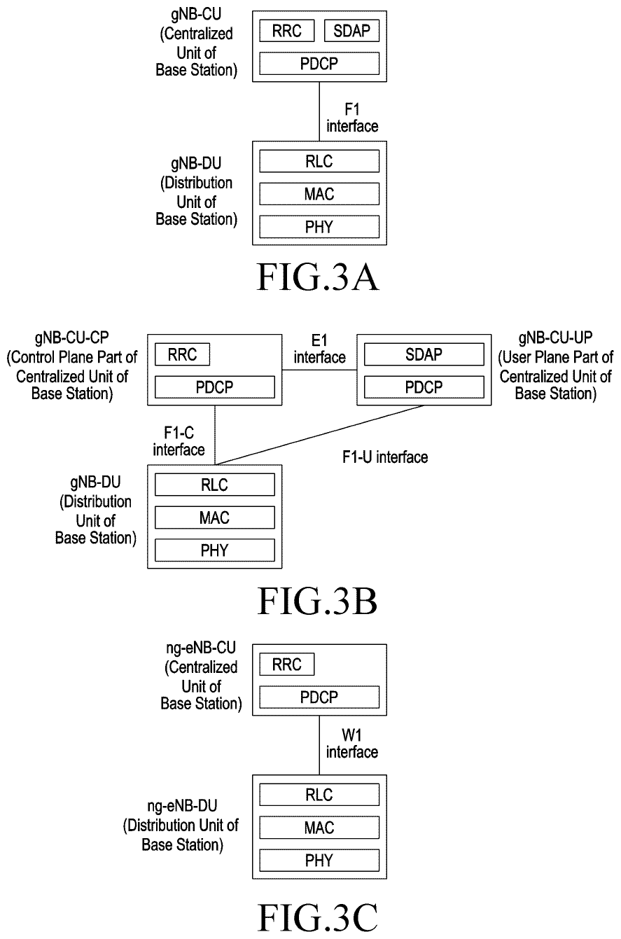

In NR system, in order to support network function virtualization, more efficient resource management and scheduling, a base station (gNB/ng-eNB) that provides a wireless network interface for user equipment (UE) can be further divided into a centralized unit gNB-CU/ng-eNB-CU (gNB central unit/ng-eNB central unit) and a distributed unit gNB-DU/ng-eNB-DU (gNB distributed unit/ng-eNB distributed unit) (abbreviated as CU and DU in the present invention), as shown in FIG. 3A. gNB-CU has radio resource control (RRC), service data adaptation protocol (SDAP) and packet data convergence protocol (PDCP) protocols, etc, while ng-eNB-CU has RRC and PDCP layers. gNB-DU/ng-eNB-DU has radio link control protocol (RLC), medium access control (MAC) and physical layer, etc. There is a standardized public interface F1 between gNB-CU and gNB-DU, and a standardized public interface W1 between ng-eNB-CU and ng-eNB-DU. The F1 interface is divided into control plane F1-C and user plane F1-U. The transport network layer of F1-C is based on IP transport. In order to transmit signaling more reliably, SCTP (stream control transmission protocol) protocol is added to IP. The protocol of the application layer is F1AP (F1 Application Protocol, F1 Application Protocol/F1 Interface Application Protocol), see 3GPP TS38.473. SCTP can provide reliable application layer message transmission. The transport layer of F1-U (F1-User, user plane of F1) is UDP/IP, and GTP-U (GPRS tunneling protocol for the user plane) is used to carry user plane protocol data unit PDU above UDP/IP. Further, for gNB-CU, as shown in FIG. 3B, gNB-CU can include gNB-CU-CP (the control plane part of the centralized unit of the base station) and gNB-CU-UP (the user plane part of the centralized unit of the base station). gNB-CU-CP includes the function of the control plane of the base station and has RRC and SDAP protocol layers, and gNB-CU-UP includes the function of the user plane of the base station and has SDAP and PDCP protocol layers. gNB-CU-CP and gNB-CU-UP are standardized public interfaces E1, and the protocol is E1AP, see 3GPP TS38.463. The interface between the control plane part of the centralized unit of the base station and the distributed unit of the base station is F1-C interface, that is, the control plane interface of F1, and the interface between the user plane part of the centralized unit of the base station and the distributed unit of the base station is F1-U interface, that is, the user plane interface of F1. In addition, in the NR system, the base station providing the E-UTRA user plane and control plane which accesses the 5G core network is called ng-eNB. In order to support virtualization, such a base station (ng-eNB) can also be further divided into a centralized unit ng-eNB-CU (gNB central unit/ng-eNB central unit) and a distributed unit ng-eNB-DU (gNB distributed unit/ng-eNB distributed unit) (abbreviated as CU and DU in the present invention), as shown in FIG. 3C. ng-eNB-CU has RRC and PDCP layers. gNB-DU/ng-eNB-DU has radio link control protocol (RLC), medium access control (MAC) and physical layer, etc. There is a standardized public interface W1 between ng-eNB-CU and ng-eNB-DU. W1 interface is divided into control plane W1-C and user plane W1-U. The transport network layer of W1-C is based on IP transport. In order to transmit signaling more reliably, SCTP protocol is added to IP. The protocol of the application layer is W1AP, see 3GPP TS37.473. The transport layer of W1-U is UDP/IP, and GTP-U is used to carry user plane protocol data unit PDU above UDP/IP.

Various embodiments of the present disclosure are further described below with reference to the accompanying drawings. The text and drawings are provided as examples only to help understand the present disclosure. They should not be construed as limiting the scope of the present disclosure in any way. Although certain embodiments and examples have been provided, based on the disclosure herein, it is obvious to those skilled in the art that changes can be made to the illustrated embodiments and examples without departing from the scope of this disclosure.

Before introducing the specific content, some assumptions and some definitions of the present invention are given below.
The message names in the present invention are only examples, and other message names can be used.
The “first” and “second” included in the message name of the present invention are only examples of messages and do not represent the execution order.
Detailed description of steps irrelevant to the present invention is omitted in the present invention.
In the present invention, the steps in each procedure can be executed in combination with each other or independently. The execution steps of each process are only examples, and other possible execution orders are not excluded.
In the present invention, the base station may be a 5G base station (such as gNB, ng-eNB), a 4G base station (such as eNB), a 6G base station or other types of access nodes.
In the present invention, data transmission refers to the reception or transmission of data.

The nodes involved in the invention are:
A first node: user equipment (UE).
A second node: a base station, a centralized unit of a base station, or a control plane part of a centralized unit of a base station, a serving base station, or a centralized unit of a serving base station, or a receiving base station, or a control plane part of a centralized unit of a receiving base station.
A third node: a base station, a centralized unit of a base station, or a control plane part of a centralized unit of a base station, a neighboring base station, or a centralized unit of a neighboring base station, or a centralized unit of a last serving base station, or a control plane part of a centralized unit of a last serving base station.
A fourth node: a distribution unit of a base station, a distribution unit of a serving base station, or a distribution unit of a receiving base station.
A fifth node: a distribution unit of a base station, a distribution unit of a neighboring base station, or a distribution unit of a last serving base station.

A sixth node: Location Management Function (LMF).

At present, the positioning technology mainly studies the reference signal configuration of user equipment in one cell, but does not study the inter-cell reference signal and/or related information configuration of user equipment. The invention mainly relates to the inter-cell reference signal and/or related information configuration of user equipment.

The invention discloses a method performed by a sixth node in a communication system, the method comprising: sending second request information to a second node, wherein the second request information is used for requesting information related to reference signal configuration of user equipment; receiving second response information from a second node, wherein the second response information includes reference signal configuration information; sending reference signal configuration activation related information to a second node; wherein the reference signal configuration information includes: at least one reference signal configuration and validity area related information corresponding to the reference signal configuration; user equipment identification related information; wherein the reference signal configuration activation related information includes: at least one reference signal configuration identification or a validity area identification corresponding to the reference signal configuration; an activation indication.

Through the above method, by receiving the reference signal configuration information from the second node and sending the reference signal configuration activation related information to the second node, the inter-cell reference signal and/or related information configuration of the user equipment can be realized, so that the user equipment can make the reference signal configuration request as required according to the reference signal configuration related information of the user equipment, thereby improving the freedom of selection of the user equipment.

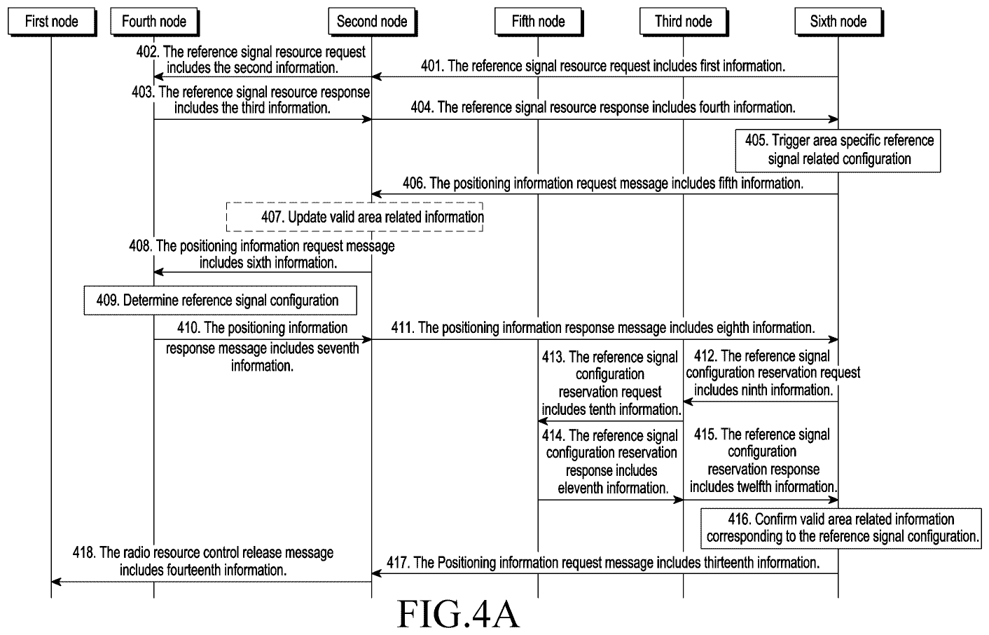

Next, a method of inter-cell reference signal and/or related information configuration according to various embodiments of the present disclosure will be described in detail with reference to FIG. 4A.

Please refer to FIG. 4A, which illustrates an example method of inter-cell reference signal and/or related information configuration according to various embodiments of the present disclosure. The example method of inter-cell reference signal and/or related information configuration may include one or more of steps 401 to 418.

In step 401, the sixth node triggers a reference signal resource interaction process, which can be used to request resources that can be used as reference signal related configuration from the third node or the second node: the sixth node sends first information to the third node or the second node, wherein the first information includes first request information related to available reference signal resources.

The first request information related to available reference signal resources may at least include one of the following information:
a reference signal resource request;
a reference signal resource time window request for requesting the validity time corresponding to the available reference signal related resources;
a first cell related identification for identifying a cell requesting allocation of resources for reference signal related configuration;
a second cell correlation identification for identifying a list of cells requesting allocation of resources for reference signal related configuration.

Herein, the first cell related identification may at least include one of the following information:
a first physical cell identification;
a first cell global identification.

Herein, the second cell related identification may at least include one of the following information:
a second physical cell identification or a second physical cell identification list;
a second cell global identification or a second cell global identification list.

The first information may be included in an existing receiving and sending point information request message. It can also be included in other existing NRPPa messages. It can also be included in a new NRPPa message, such as an available reference signal resource request message.

The third node or the second node determines the cell that needs to provide available reference signal related resources according to the first cell related identification and/or the second cell related identification. The third node or the second node determines the validity time corresponding to which needs to provide the available reference signal related resources, according to the reference signal resource time window request.

In step 404, After receiving the first information, the third node or the second node sends the fourth information to the sixth node according to the content of the first information, herein the fourth information may include the first response information related to the available reference signal resources.

The first response information related to available reference signal resources may at least include one of the following information:
a first cell related identification;
a third cell related identification;
reference signal resource related information of the first cell;
reference signal resource related information of the third cell;
time window related information of the first cell;
time window related information of the third cell.

Herein, the third cell related identification may at least include one of the following information:
a third physical cell identification or a third physical cell identification list;
a third cell global identification or a third cell global identification list.

It should be noted that the third cell related identification may be a subset of the second cell related identification. That is to say, the second node can select some or all cells from a plurality of cells identified by the second cell related identification included in the first request information sent by the sixth node as the cells identified by the third cell related identification.

Herein, the reference signal resource related information of the first cell or the reference signal resource related information of the third cell may at least include one of the following information:
total/overall resources of the reference signal;
available reference signal resources or unused reference signal resources;
used reference signal resources or configured reference signal configuration.

The time window related information of the first cell or the time window related information of the third cell can be used to indicate the validity time of the reference signal resource related information of the first cell or the third cell, and can at least include one of the following information:
start time related information;
end time related information;
duration related information.

The fourth information may be included in the existing receiving and sending point information response message. It can also be included in other existing NRPPa messages. It can also be included in new NRPPa messages, such as available reference signal resource response messages.

The sixth node identifies the cell that provides available reference signal related resources according to the first cell related identification and/or the third cell related identification. The sixth node confirms the corresponding available reference signal resource related information provided by the first or third cell according to the reference signal resource related information of the first or third cell. The sixth node confirms the provided validity time corresponding to the available reference signal related resources according to the time window related information of the first or third cell.

In step 402, If the third node or the second node is the centralized unit of the base station, or the control plane part of the centralized unit of the base station, or the centralized unit of a serving base station, or the control plane part of the centralized unit of the serving base station, the third node or the second node triggers a reference signal resource interaction process, which can be used to request resources that can be used as reference signal related configuration from the fifth node or the fourth node: the third node or the second node sends the second information to the fifth node or the fourth node, herein the second information includes the first request information related to the available reference signal resources.

The second information may be included in an existing receiving and sending information request message. It can also be included in other existing F1AP messages. It can also be included in a new F1AP message, such as an available reference signal resource request message.

The fifth node or the fourth node determines the cell that needs to provide available reference signal related resources according to the first cell related identification and/or the second cell related identification. The fifth node or the fourth node determines the validity time corresponding to which needs to provide the available reference signal related resources, according to the reference signal resource time window request.

In step 403, After receiving the second information, the fifth node or the fourth node sends third information to the third node or the second node according to the content of the second information, herein the third information includes the first response information related to the available reference signal resources.

The third information may be included in the existing receiving and sending point information response message. It can also be included in other existing F1AP messages. It can also be included in a new F1AP message, such as an available reference signal resource response message.

The third node or the second node identifies the cell that provides the available reference signal related resources according to the first cell related identification and/or the third cell related identification. The third node or the second node confirms the corresponding available reference signal resource related information provided by the first or third cell according to the reference signal resource related information of the first or third cell. The third node or the second node confirms the provided validity time corresponding to the available reference signal related resources according to the time window related information of the first or third cell.

Through the step 401 to 404, the sixth node requests the available reference signal resources related information from the third node or the second node, and the third node or the second node requests the available reference signal resources related information from the fifth node or the fourth node, the sixth node can obtain the available reference signal resources in the area more timely, thus ensuring that the sixth node can provide an appropriate area for reference signal configuration.

Before introducing the next steps, it should be pointed out that there may be the following options regarding the relationship between the validity area and the reference signal configuration, and the relationship within the validity area and the relationship among the validity areas:
Option 1: Each validity area can be configured with only one reference signal configuration;
Option 2: Each validity area can be configured with multiple reference signal configurations, wherein each reference signal configuration is validity in the whole validity area;
Option 3: Each validity area can be configured with multiple reference signal configurations, wherein each reference signal configuration is only validity in part of the validity area;
Option A: There is no overlap between validity areas;
Option B: There is overlap between validity areas;
Option one, two, three and option A, B can be combined. For example, option one A means that each validity area can be configured with only one reference signal configuration, and there is no overlap between validity areas.

The specific information transmitted in the following steps may be different due to different options. If some specific information is mainly applicable to a certain option, the corresponding option will be marked behind the specific information. It should be pointed out that even if the corresponding option is marked, it does not mean that some specific information only applies to this option, and specific information can apply to all options in principle.

In step 405, optionally, the sixth node triggers an area specific reference signal related configuration process. The sixth node may generate validity area related information corresponding to the reference signal configuration according to the received fourth information, or according to the related information configured by the operation administration and maintenance node.

In step 406, the sixth node triggers a positioning information interaction process, which can be used to request reference signal configuration related information from the second node: the sixth node sends fifth information to the second node, wherein the fifth information includes second request information for requesting reference signal configuration related information of the user equipment.

The second request information may at least include one of the following information:
an area specific reference signal configuration request for requesting reference signal configuration and corresponding validity area related information;
a reference signal pre-configuration request for requesting a plurality of reference signal (pre-) configurations and/or corresponding validity area related information;
validity area related information;
user equipment first identification.

Herein, the validity area related information may at least include one of the following information:
first validity area related information;
second validity area related information.

Herein, the first validity area related information may at least include one of the following information:
a first validity area identification;
a recommended or suggested fourth cell related identification list, which is used to indicate a cell or a cell list recommended or suggested by the sixth node to the second node for receiving reference signal transmission;
a fourth cell related identification list, which is used to indicate a cell or a cell list determined by the sixth node to receive the reference signal transmission;
a number of reference signal configuration or reference signal pre-configuration, which is used to indicate the number of the reference signal configuration or pre-configuration that needs to be provided.

The (recommended or suggested) fourth cell related identification list may at least contain one of the following information:
a fourth physical cell identification list;
a fourth cell global identification list.

Herein, the second validity area related information may at least include one of the following information:
a second validity area list containing one or more second validity areas;
a second validity area identification list.

Herein, the second validity area may at least contain one of the following information:
a recommended or suggested fifth cell related identification list, which is used to indicate a cell or a cell list recommended or suggested by the sixth node to the second node for receiving reference signal transmission;
a fifth cell related identification list, which is used to indicate a cell or a cell list determined by the sixth node to receive the reference signal transmission;
a number of reference signal configuration or reference signal pre-configuration, which is used to indicate the number of the reference signal configuration or pre-configuration that needs to be provided.

Herein, the (recommended or suggested) fifth cell related identification list may at least contain one of the following information:
a fifth physical cell identification list;
a fifth cell global identification list.

The fifth information may be included in an existing positioning information request message. It can also be included in other existing NRPPa messages. It can also be included in new NRPPa messages, such as reference signal configuration or pre-configuration request messages.

The second node determines the number of reference signal configuration or reference signal pre-configuration that needs to be provided according to the number of reference signal configuration or the number of reference signal pre-configuration. It should be noted that one possible implementation is that when the sixth node provides one of the area specific reference signal configuration request and the reference signal pre-configuration request, it may also request to configure the reference signal configuration and the reference signal pre-configuration at the same time.

By the way that the sixth node provides the validity area related information to the second node, the second node can confirm or determine the validity area corresponding to the reference signal configuration according to the validity area related information, thus ensuring that the second node can provide a more suitable reference signal configuration.

Furthermore, by the way that the sixth node generates the second validity area related information, the second node can determine or request one or more reference signal configurations corresponding to one or more second validity areas according to the received second validity area related information. By configuring multiple validity areas and corresponding multiple reference signal configurations at one time, on the one hand, the flexibility of reference signal configurations corresponding to validity areas is improved, and on the other hand, the user equipment can make the reference signal configuration request as needed according to the situation, thus improving the freedom of selection of the user equipment.

In step 407, the second node may update the validity area related information and generate the validity area first update information, which may at least include one of the following information:
third validity area related information;
fourth validity area related information.

The third validity area related information may at least include one of the following information:
the first validity area identification;
A recommended or suggested sixth cell related identification list, which is used to indicate a cell or a cell list for receiving reference signal transmission recommended or suggested by the second node (selected or updated);
A sixth cell related identification list, which is used to indicate a cell or a cell list determined (or selected or updated) by the second node to receive the reference signal transmission.

Herein, the (recommended or suggested) sixth cell related identification list may at least contain one of the following information:
a sixth physical cell identification list;
a sixth cell global identification list.

The fourth validity area related information may at least include one of the following information:
a fourth validity area list containing one or more fourth validity areas;
a fourth validity area identification list.

The fourth validity area may at least contain one of the following information:
a recommended or suggested seventh cell related identification list, which is used to indicate a cell or a cell list recommended or suggested by the second node to receive the reference signal transmission;
a seventh cell related identification list, which is used to indicate a cell or a cell list determined by the second node to receive the reference signal transmission.

Herein, the (recommended or suggested) seventh cell related identification list may at least contain one of the following information:
a seventh physical cell identification list;
a seventh cell global identification list.

Herein the third validity area related information is updated based on the first validity area related information, and correspondingly, the (recommended or suggested) sixth cell related identification list can be a subset of the (recommended or suggested) fourth cell related identification list.

Herein the fourth validity area related information is updated based on the second validity area related information, and correspondingly, the (recommended or suggested) seventh cell related identification list can be a subset of the (recommended or suggested) fifth cell related identification list.

Herein the fourth validity area identification list may be a subset of the second validity area identification list.

That is, the second node can select (or update) all or part of the cells as the (recommended or suggested) cell related identification list based on the multiple cells indicated by the (recommended or suggested) cell related identification list included in the fifth information.

In step 411, After receiving the fifth information, the second node sends eighth information to the sixth node according to the content of the fifth information (step 411), wherein the eighth information includes second response information related to the reference signal configuration of the user equipment.

The second response information related to the reference signal configuration may at least include one of the following information:
reference signal first configuration information;
user equipment identification related information.

The reference signal first configuration information may at least include one of the following information:
first reference signal configuration related information;
second reference signal configuration related information.

The first reference signal configuration related information may at least include one of the following information:
a first reference signal configuration identification;
a first reference signal configuration;
fifth validity area related information.

The fifth validity area related information may at least include one of the following information:
the first validity area identification;
a recommended or suggested eighth cell related identification list, which is used to indicate a cell or a cell list recommended or suggested by the second node to receive the reference signal transmission;
an eighth cell related identification list, which is used to indicate a cell or a cell list determined by the second node to receive the reference signal transmission.

Herein, the (recommended or suggested) eighth cell related identification list may at least contain one of the following information:
an eighth physical cell identification list;
an eighth cell global identification list.

The second reference signal configuration related information may at least include one of the following information:
a second reference signal configuration identification list;
a second reference signal configuration list;
sixth validity area related information.

The sixth validity area related information may at least include one of the following information:
a sixth validity area list containing one or more sixth validity areas;
a sixth validity area identification list.

Herein, the sixth validity area may at least contain one of the following information:
a recommended or suggested ninth cell related identification list, which is used to indicate a cell or a cell list recommended or suggested by the second node to receive reference signal transmission;
a ninth cell related identification list, which is used to indicate a cell or a cell list determined by the second node to receive the reference signal transmission.

Herein, the (recommended or suggested) ninth cell related identification list may at least contain one of the following information:
a ninth physical cell identification list;
a ninth cell global identification list.

Herein the fifth validity area related information may be the third validity area related information. It can also be updated based on the third validity area related information: correspondingly, the (recommended or suggested) eighth cell related identification list can be a subset of the (recommended or suggested) sixth cell related identification list.

Herein the sixth validity area related information may be the fourth validity area related information. It can also be updated based on the fourth validity area related information, and correspondingly, the (recommended or suggested) ninth cell related identification list can be a subset of the (recommended or suggested) seventh cell related identification list.

That is, the second node can select (or update) all or part of the cells as the (recommended or suggested) cell related identification list based on the multiple cells indicated by the (recommended or suggested) cell related identification list included in the fifth information.

Herein the sixth validity area identification list may be a subset of the fourth validity area identification list.

Herein, the user equipment identification related information may at least include one of the following information:
an inactive radio network temporary identification (I-RNTI);
a connected radio network temporary identification (C-RNTI);
user equipment first identification.

The eighth information may be included in the existing positioning information response message. It can also be included in other existing NRPPa messages. It can also be included in new NRPPa messages, such as available reference signal resource response messages.

The sixth node stores the fifth or sixth validity area related information. The sixth node identifies a validity area corresponding to the reference signal configuration according to the first or second reference signal configuration related information. The sixth node stores the user equipment identification related information. The sixth node stores the reference signal configuration identification.

It should be noted that the second node may allocate the user equipment first identification, or the sixth node may allocate the user equipment first identification. If the second node allocates the user equipment first identification, the user equipment first identification is only included in the eighth information, and the sixth node associates the user equipment first identification with the reference signal first configuration information after receiving the user equipment first identification. The sixth node stores the user equipment first identification. If the sixth node allocates the user equipment first identification, the user equipment first identification is included in the fifth information or may be included in the eighth information, and the second node associates the user equipment first identification with the reference signal first configuration information after receiving the user equipment first identification; The second node stores the user equipment first identification.

In step 408, If the second node is a centralized unit of the base station, or a control plane part of the centralized unit of the base station, or a centralized unit of the serving the base station, or a control plane part of the centralized unit of the serving the base station, the second node triggers a positioning information interaction process, which can be used to request a reference signal related configuration from the fourth node: the second node sends sixth information to the fourth node, wherein the sixth information includes the second request information for requesting the reference signal configuration related information. It should be pointed out that the sixth information also includes the validity area first update information.

The sixth information may be included in an existing positioning information request message. It can also be included in other existing F1AP messages. It can also be included in new F1AP messages, such as the reference signal configuration or pre-configuration request message.

In step 410, After receiving the sixth information, the fourth node sends seventh information to the second node according to the content of the sixth information, wherein the seventh information includes the second response information related to the reference signal configuration.

The seventh information may be included in an existing positioning information response message. It can also be included in other existing F1AP messages. It can also be included in new F1AP messages, such as a reference signal configuration or preconfigured response message.

In step 409, The fourth node determines or provides a reference signal configuration related to the validity area according to the sixth information. The fourth node may update the validity area first update information according to the validity area first update information in the sixth information and the latest reference signal resource situation, and generate the validity area second update information. The fourth node may also directly use the validity area first update information as the validity area second update information.

Through the above-mentioned way that the sixth node requests the second node and the second node requests the fourth node for reference signal configuration related information, the sixth node can obtain one or more reference signal configurations associated with one or more validity areas, thus ensuring that the sixth node can have enough flexibility to provide appropriate reference signal configuration for the user equipment in the validity areas. By the way that the fourth node can generate the validity area second update information according to the current situation, the flexibility of the fourth node in using the reference signal resources is ensured.

In step 412, the sixth node triggers a reference signal configuration reservation interactive process, which can be used to request the third node to reserve the reference signal configuration: the sixth node sends the ninth information to the third node, wherein the ninth information includes the third request information requesting to reserve the reference signal configuration related information.

Herein, the third request information requesting to reserve information related to reference signal configuration may at least include one of the following information:
a reference signal configuration reservation request;
requested reserved reference signal configuration related information;
user equipment identification related information.

Herein, the requested reserved reference signal configuration related information may at least include one of the following information:
reference signal second configuration information.

The reference signal second configuration information may at least include one of the following information:
third reference signal configuration related information;
fourth reference signal configuration related information.

The third reference signal configuration related information may at least include one of the following information:
a first reference signal configuration identification;
a first reference signal configuration;
seventh validity area related information.

The seventh validity area related information may at least include one of the following information:
the first validity area identification;
a tenth cell related identification list.

Herein, the tenth cell related identification list may at least contain one of the following information:
a tenth physical cell identification list;
a tenth cell global identification list.

The fourth reference signal configuration related information may at least include one of the following information:
a fourth reference signal configuration identification list;
a fourth reference signal configuration list;
eighth validity area related information.

The eighth validity area related information may at least include one of the following information:
an eighth validity area list containing one or more eighth validity areas;
an eighth validity area identification list.

The eighth validity area may at least contain one of the following information:
an eleventh cell related identification list;

Herein, the eleventh cell related identification list may at least contain one of the following information:
an eleventh physical cell identification list;
an eleventh cell global identification list.

Herein, the seventh validity area related information may be the fifth validity area related information. It can also be updated based on the fifth validity area related information: correspondingly, the tenth cell related identification list can be a subset of the (recommended or suggested) eighth cell related identification list.

Herein, the eighth validity area related information may be the sixth validity area related information. It can also be updated based on the related information of the sixth validity area, and correspondingly, the eleventh cell related identification list can be a subset of the (recommended or suggested) ninth cell related identification list.

Herein the eighth validity area identification list may be a subset of the sixth validity area identification list.

Herein, the user equipment identification related information may at least include one of the following information:
an inactive radio network temporary identification (I-RNTI);
a connected radio network temporary identification (C-RNTI);
user equipment first identification.

The ninth information may be included in an existing NRPPa message. It can also be included in a new NRPPa message, such as a reference signal configuration reservation request message.

The sixth node provides the seventh or eighth validity area related information to the third node according to the fifth or sixth validity area related information. The tenth or eleventh cell related identification list only includes the cells of the third node.

The third node identifies the cell corresponding to the reference signal configuration which needs to reserve the reference signal configuration, according to the seventh or eighth validity area related information. The third node stores the user equipment identification related information. The third node stores the reference signal configuration identification.

The sixth node may assign the user equipment first identification. After receiving the user equipment first identification, the third node associates the user equipment first identification with the reference signal second configuration information. The third node stores the user equipment first identification.

Through the above-mentioned way that the sixth node requests the third node to reserve the reference signal configuration, the third node can accept or reject the request of reservation for the reference signal configuration according to the usage of its own radio resources, thus ensuring the decision-making power of the third node on the use of radio resources.

In step 415, After receiving the ninth information, the third node sends the twelfth information to the sixth node according to the content of the ninth information, wherein the twelfth information includes the third response information related to reserving reference signal configuration.

The third response information related to reserving reference signal configuration may at least include one of the following information:
first reference signal configuration response related information;
second reference signal configuration response related information.

The first reference signal configuration response related information may at least include one of the following information:
an indication of accepting or rejecting to reserve for the third reference signal configuration;
an indication of successful or unsuccessful reservation of the third reference signal configuration;
related information of accepting or successfully reserving for the third reference signal configuration;
related information of rejecting or unsuccessfully reserving for the third reference signal configuration.

Herein, the related information of rejecting or unsuccessfully reserving for the third reference signal configuration, or the related information of rejecting or unsuccessfully reserving for the third reference signal configuration, may at least include the twelfth cell related identification list.

Herein the twelfth cell related identification list may at least contain one of the following information:
a twelfth physical cell identification list;
a twelfth cell global identification list.

It should be pointed out that if it is the related information of accepting or successfully reserving for the third reference signal configuration, the twelfth cell related identification list indicates the cell that accepts or successfully reserves the third reference signal configuration; If it is the related information of rejecting or unsuccessfully reserving for the third reference signal configuration, the twelfth cell related identification list indicates the cell that rejects or unsuccessfully reserves the first reference signal configuration.

The second reference signal configuration response related information may at least include one of the following information:
a related information list of accepting or successfully reserving for the reference signal configuration, which includes one or more related information of accepting or successfully reserving for the reference signal configuration;
a related information list of rejecting or unsuccessfully reserving for the reference signal configuration, which includes one or more related information of rejecting or unsuccessfully reserving for the reference signal configuration;

Herein, the related information of accepting or successfully reserving for the reference signal configuration may at least include one of the following information:
a fifth reference signal configuration identification list;
a ninth validity area related information.

The ninth validity area related information may at least include one of the following information:
a ninth validity area list containing one or more ninth validity areas;
a ninth validity area identification list.

The ninth validity area may at least contain one of the following information:
a thirteenth cell related identification list.

Herein, the thirteenth cell related identification list at least includes one of the following information:
a thirteenth physical cell identification list;
a thirteenth cell global identification list.

It should be noted that the fifth reference signal configuration identification list is a subset of the fourth reference signal configuration identification list. The ninth validity area list is a subset of the eighth validity area list. The ninth validity area identification list is a subset of the eighth validity area identification list. The thirteenth cell related identification list is a subset of the eleventh cell related identification list.

Herein, the related information of rejecting or unsuccessfully reserving for the reference signal configuration may at least include a sixth reference signal configuration identification list.

It should be noted that the sixth reference signal configuration identification list is a subset of the fourth reference signal configuration identification list.

The twelfth information may be included in an existing NRPPa message. It can also be included in a new NRPPa message, such as a reference signal configuration reservation response message.

The sixth node stores the first or second reference signal configuration response related information. The sixth node confirms the reserved reference signal configuration and/or validity area related information according to the first or second reference signal configuration response related information.

In step 413, If the second node is a centralized unit of a base station, or a control plane part of a centralized unit of a base station, or a centralized unit of a neighboring base station, or a control plane part of a centralized unit of a neighboring base station: the third node triggers a reference signal configuration reservation interactive process, which can be used to request the fifth node to reserve a reference signal related configuration: the third node sends the tenth information to the fifth node, wherein the tenth information includes the third request information for requesting to reserve reference signal configuration related information.

The tenth information may be included in an existing F1AP message. It can also be included in a new F1AP message, such as a reference signal configuration reservation request message.

In step 414, After receiving the tenth information, the fifth node sends eleventh information to the third node according to the content of the tenth information, wherein the eleventh information includes the third response information related to reserving reference signal configuration.

The eleventh information may be included in an existing F1AP message. It can also be included in a new F1AP message, such as a reference signal configuration reservation response message.

By the way that the fifth node responds the reservation for the reference signal configuration to the third node and the third node responds the reservation for the reference signal configuration to the sixth node, it is ensured that the reference signal configuration is properly reserved, and through the response of the validity area related information, it is ensured that the network side has a consistent understanding of the reference signal configuration and the associated validity area. The third node or the fifth node ensures the flexibility of using radio resources by accepting or rejecting the requested reference signal configuration and/or the corresponding validity area.

In step 416, the sixth node confirms the final reference signal (pre-) configuration and the corresponding validity area related information according to the received twelfth information. The sixth node may receive the twelfth information from a plurality of third nodes, and generate thirteenth information including all or part of accepted or successfully reserved reference signal (pre-) configuration and validity area related information, that is, reference signal third configuration information, according to a plurality of third response information contained in the twelfth information.

In step 417, the sixth node sends thirteenth information to the second node or the second node sends thirteenth information to the fourth node, and the thirteenth information includes the reference signal third configuration information.

The reference signal third configuration information may at least include one of the following information:
fifth reference signal configuration related information;
sixth reference signal configuration related information;
first reference signal configuration activation related information.

The fifth reference signal configuration related information may at least include one of the following information:
a first reference signal configuration identification;
a first reference signal configuration;
tenth validity area related information.

The tenth validity area related information may at least include one of the following information:
the first validity area identification;
a fourteenth cell related identification list.

Herein, the fourteenth cell related identification list may at least contain one of the following information:
a fourteenth physical cell identification list;
a fourteenth cell global identification list.

The sixth reference signal configuration related information may at least include one of the following information:
a seventh reference signal configuration identification list;
a seventh reference signal configuration list;
eleventh validity area related information.

The eleventh validity area related information may at least include one of the following information:
an eleventh validity area list containing one or more eleventh validity areas;
an eleventh validity area identification list.

The eleventh validity area may at least contain one of the following information:
a fifteenth cell related identification list;

Herein, the fifteenth cell related identification list may at least contain one of the following information:
a fifteenth physical cell identification list;
a fifteenth cell global identification list.

The first reference signal configuration activation related information may at least include one of the following information:
a third reference signal configuration identification;
a third reference signal configuration;
a twelfth validity area identification;
a twelfth validity area;
an activation indication.

The thirteenth information may be included in an existing positioning information request message. It can also be included in other existing NRPPa message. It can also be included in a new NRPPa message, such as a reference signal configuration message.

The third reference signal configuration identification is one reference signal configuration identification of the first reference signal configuration identification and the seventh reference signal configuration identification list.

The third reference signal configuration is one reference signal configuration of the first reference signal configuration and the seventh reference signal configuration list.

The twelfth validity area identification is one validity area identification of the first validity area identification and the eleventh validity area identification list.

The twelfth validity area is one validity area of the first validity area and the eleventh validity area list.

In step 418, the second node sends fourteenth information to the first node, and the fourteenth information includes the reference signal third configuration information.

The fourteenth information may be included in an existing radio resource control release message. It can also be included in other existing RRC messages. It can also be included in a new RRC message, such as a reference signal configuration message.

The first node stores the fifth or sixth reference signal configuration related information.

The first node configures and activates the content in the related information according to the first reference signal, and transmits the reference signal in the validity area.

The inter-cell reference signal and/or related information configuration method provided by the invention ensures that the user equipment can use the same reference signal configuration in a plurality of cells through the way of interaction between nodes, thereby reducing the reference signal reconfiguration of the user equipment by the network side and saving the overhead of air interface; and reducing the reference signal configuration request of the user equipment to the network side, saving the processing burden of the network side and saving the energy consumption of the user equipment.

An example method of inter-cell reference signal and/or related information configuration activation according to various embodiments of the present disclosure will be described in detail with reference to FIG. 4A.

Please refer to FIG. 4B, which illustrates an example method of inter-cell reference signal and/or related information configuration activation according to various embodiments of the present disclosure. The example method of inter-cell reference signal and/or related information configuration activation may include one or more of steps 451 to 460.

It is worth mentioning that the procedure contained in FIG. 4B may occur after the procedure contained in FIG. 4A, that is, FIG. 4B may perform the subsequent configuration activation procedure based on the configuration procedure of FIG. 4A. And the second node in FIG. 4B may correspond to the third node in FIG. 4A, the third node in FIG. 4B may correspond to the second node in FIG. 4A, the fourth node in FIG. 4B may correspond to the fifth node in FIG. 4A, and the fifth node in FIG. 4B may correspond to the fourth node in FIG. 4A.

In step 451, a first node sends a radio resource control resume request message to a second node, wherein the message includes an inactive wireless network temporary identification (I-RNTI) and a reference signal request (indication).

Optionally, the first node may initiate a reference signal request (indication) after entering other validity areas.

In step 452, the second node sends a retrieve user equipment context request message to the third node.

In step 453, that third node send a retrieve user equipment context response message to the second node, and the message may contain the user equipment first identification.

In step 454 or 455, the second node or the third node sends a positioning information update message to the sixth node, which includes fifteenth information related to the reference signal (pre-) configuration, and the fifteenth information may at least include one of the following information:
a reference signal request (indication);
a fourth reference signal configuration identification;
a thirteenth validity area identification;
a thirteenth validity area.

Herein the fourth reference signal configuration identification is one reference signal configuration identification list of the first reference signal configuration identification and the seventh reference signal configuration identification list.

The thirteenth validity area identification is one validity area identification of the first validity area identification and the eleventh validity area identification list.

The thirteenth validity area is one validity area of the first validity area and the eleventh validity area list.

It should be noted that the specific content transmitted in the fifteenth information varies from embodiment to embodiment:

In one embodiment, the second node determines the reference signal configuration that needs to be activated. In this case, the second node finds the reserved reference signal configuration and validity area corresponding to the identification according to the received inactive radio network temporary identification (step 451) or the user equipment first identification (step 453), determines the reference signal configuration that needs to be activated, and sends the fourth reference signal configuration identification or the thirteenth validity area identification to the sixth node. After receiving the fourth reference signal configuration identification or the thirteenth validity area identification, the sixth node triggers a subsequent reference signal configuration activation process.

In another embodiment, the sixth node determines the reference signal configuration that needs to be activated. In this case, the second node can find the reserved reference signal configuration and validity area corresponding to the identification, according to the received inactive radio network temporary identification (step 451) or the user equipment first identification (step 453), and send the thirteenth validity area to the sixth node. After receiving the thirteenth validity area, the sixth node finds the reference signal configuration that meets the conditions of the thirteenth validity area, determines the reference signal configuration that needs to be activated, and triggers the subsequent reference signal configuration activation process.

Herein, the reference signal configuration to be activated may at least include one of the following information:
a fourth reference signal configuration identification;
a thirteenth validity area identification;
a thirteenth validity area.

In another embodiment, the sixth node determines the reference signal configuration that needs to be activated. In this case, after receiving the fifteenth information, the sixth node finds the reserved reference signal configuration and validity area corresponding to the user equipment, determines the reference signal configuration that needs to be activated, and triggers the subsequent reference signal configuration activation process.

Herein, the reference signal configuration to be activated may at least include one of the following information:
a fourth reference signal configuration identification;
a thirteenth validity area identification;
a thirteenth validity area.

In step 456, the sixth node sends a positioning activation request message to the second node, or the second node sends a positioning activation request message to the fourth node, which includes sixteenth information related to the reference signal (pre-) configuration activation, and the sixteenth information may at least include one of the following information:
a fourth reference signal configuration identification;
a thirteenth validity area identification;
a fourteenth validity area.

Herein the fourth reference signal configuration identification is one reference signal configuration identification of the first reference signal configuration identification and the seventh reference signal configuration identification list.

The thirteenth validity area identification is one validity area identification of the first validity area identification and the eleventh validity area identification list.

The fourteenth validity area may be the thirteenth validity area or a sub-area of the thirteenth validity area (the cells contained in the sub-area must be in the area, and the cells contained in the area are not necessarily in the sub-area).

The second node or the fourth node identifies the reference signal configuration that needs to be activated according to the fourth reference signal configuration identification, or the second node or the fourth node identifies the reference signal configuration that needs to be activated according to the thirteenth validity area identification. The second node or the fourth node identifies the cell that needs to activate the reference signal transmission according to the thirteenth validity area identification or the fourteenth validity area.

In step 457, the second node sends a positioning activation response message to the sixth node or the fourth node sends a positioning activation response message to the second node.

In step 458, the sixth node sends a positioning deactivation message to the third node, or the third node sends a positioning deactivation message to the fifth node, which includes seventeenth information related to the reference signal (pre-) configuration deactivation, and the seventeenth information may at least include one of the following information:
a reference signal configuration identification;
a validity area identification.

Herein the reference signal configuration identification is one reference signal configuration identification of the first reference signal configuration identification and the seventh reference signal configuration identification list. The reference signal configuration identification is the configuration identification corresponding to the currently activated reference signal.

The validity area identification is one validity area identification of the first validity area identification and the eleventh validity area identification list. The validity area identification is a validity area identification corresponding to the currently activated reference signal.

The third node or the fifth node identifies the reference signal configuration that needs to be deactivated according to the reference signal configuration identification or the validity area identification.

In step 459, the second node sends a radio resource control release message to the first node, which includes eighteenth information related to the reference signal transmission activation, and the eighteenth information may at least include one of the following information:
a transmission activation request;
a fourth reference signal configuration identification;
a thirteenth validity area identification;
a fourteenth validity area.

Herein the fourth reference signal configuration identification is one reference signal configuration identification of the first reference signal configuration identification and the seventh reference signal configuration identification list.

The thirteenth validity area identification is one validity area identification of the first validity area identification and the eleventh validity area identification list.

The fourteenth validity area may be the thirteenth validity area or a sub-area of the thirteenth validity area (the cells contained in the sub-area must be in the area, and the cells contained in the area are not necessarily in the sub-area).

The first node confirms that the eighteenth information is related to the reference signal transmission activation according to the transmission activation request. The first node identifies a reference signal that needs to be activated for transmission according to the fourth reference signal configuration identification or the thirteenth validity area identification. The first node identifies a cell that needs to activate reference signal transmission according to the fourteenth validity area.

In step 460, the sixth node sends a positioning measurement request message to the second node, or the second node sends a positioning measurement request message to the fourth node, which includes nineteenth information related to the reference signal (pre-) measurement, and the nineteenth information may at least include one of the following information:
a fourth reference signal configuration identification;
a thirteenth validity area identification;
a fifteenth validity area.

Herein the fourth reference signal configuration identification is one reference signal configuration identification of the first reference signal configuration identification and the seventh reference signal configuration identification list.

The thirteenth validity area identification is one validity area identification of the first validity area identification and the eleventh validity area identification list.

The fifteenth validity area may be the thirteenth or fourteenth validity area or a sub-area of the thirteenth or fourteenth validity area (the cells contained in the sub-area must be in the area, and the cells contained in the area are not necessarily in the sub-area).

The second node or the fourth node identifies the reference signal to be measured according to the fourth reference signal configuration identification or the thirteenth validity area identification. The second node or the fourth node identifies the cell that needs to measure the reference signal according to the fifteenth validity area.

By the way that the first node requests to activate the reference signal (pre-) configuration and the second node to the sixth node negotiate the way to activate the specific reference signal (pre-) configuration, the flexibility of using the reference signal (pre-) configuration is ensured, and the first node can use the best reference signal configuration for reference signal transmission, thus ensuring the positioning performance.

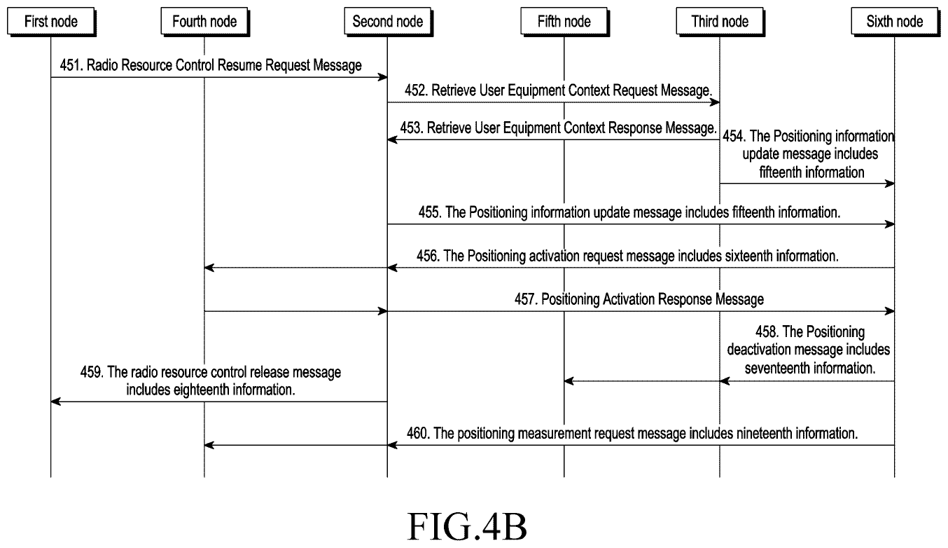

FIG. 5 illustrates a block diagram of a network device according to an embodiment of the present disclosure.

A network node in the network can be used to implement the second node to the sixth node and the like in the present invention. Referring to FIG. 5, the network node according to the present invention includes a transceiver 510, a controller 520 and a memory 530. The transceiver 510, the controller 520 and the memory 530 are configured to perform the operations of the methods and/or embodiments of the present invention. Although the transceiver 510, the controller 520 and the memory 530 are shown as separate entities, they may be implemented as a single entity, such as a single chip. The transceiver 510, the controller 520 and the memory 530 may be electrically connected or coupled to each other. The transceiver 510 may transmit and receive signals to and from other network nodes. The controller 520 may include one or more processing units, and may control the network device to perform the operations and/or functions according to one of the above embodiments. The memory 530 may store instructions for implementing the operations and/or functions of one of the above embodiments described.

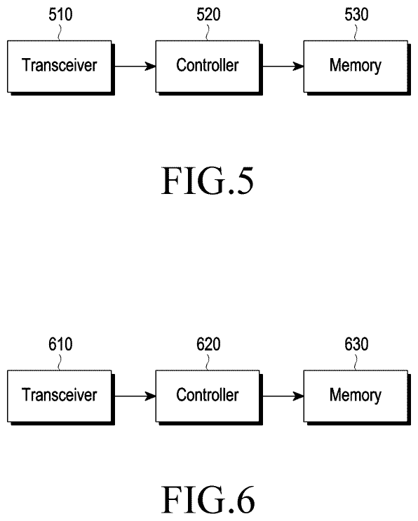

FIG. 6 illustrates a block diagram of a user equipment (UE) according to an embodiment of the present disclosure.

A user equipment in the network can be used to implement the first node and the like in the present invention. Referring to FIG. 6, the UE according to the present invention includes a transceiver 610, a controller 620 and a memory 630. The transceiver 610, the controller 620 and the memory 630 are configured to perform the operations of the methods and/or embodiments of the present invention. Although the transceiver 610, the controller 620 and the memory 630 are shown as separate entities, they may be implemented as a single entity, such as a single chip. The transceiver 610, the controller 620 and the memory 630 may be electrically connected or coupled to each other. The transceiver 610 may transmit and receive signals to and from other network nodes. The controller 620 may include one or more processing units, and may control the UE to perform the operations and/or functions according to one of the above embodiments. The memory 630 may store instructions for implementing the operations and/or functions of one of the above embodiments described.

According to an aspect of the present disclosure, there is provided a method performed by a sixth node in a communication system, the method comprising: sending second request information to a second node, wherein the second request information is used for requesting information related to a reference signal configuration of a user equipment; receiving second response information from the second node, wherein the second response information includes reference signal configuration information; and sending reference signal configuration activation related information to the second node; wherein the reference signal configuration information includes: at least one reference signal configuration and validity area related information corresponding to the reference signal configuration; and user equipment identification related information; wherein the reference signal configuration activation related information includes: at least one reference signal configuration identification or a validity area identification corresponding to the reference signal configuration; and an activation indication.

According to the method performed by the sixth node in a communication system according to the present disclosure, wherein the second request information includes at least one of: an area specific reference signal configuration request; a reference signal pre-configuration request; the validity area related information; and user equipment first identification.

According to the method performed by the sixth node in a communication system according to the present disclosure, wherein the method further comprises: sending first request information to the second node, wherein the first request information is used for requesting information related to available reference signal resources; and receiving first response information from the second node, wherein the first request information includes at least one of the following: a reference signal resource request; a reference signal resource time window request; a cell related identification; and a first cell related identification list; wherein the first response information includes at least one of: a cell related identification; a second cell related identification list; reference signal resource related information; a reference signal resource related information list; time window related information; and a time window related information list.

According to the method performed by the sixth node in a communication system according to the present disclosure, wherein the reference signal resource related information comprises at least one of: total/overall resources of a reference signal; available reference signal resources or unused reference signal resources; and used reference signal resources or a configured reference signal configuration.

According to the method performed by the sixth node in a communication system according to the present disclosure, wherein the method further comprises: sending third request information to a third node, wherein the third request information is used for requesting information related to reserved reference signal configuration; and receiving third response information from the third node, wherein the third request information includes at least one of the following: a reference signal configuration reservation request; requested reserved reference signal configuration related information; and the user equipment identification related information; wherein the third response information includes at least one of: an indication of accepting or rejecting to reserve for the reference signal configuration; an indication of successful or unsuccessful reservation of the reference signal configuration; related information of accepting or successfully reserving for the reference signal configuration; a related information list of accepting or successfully reserving for the reference signal configuration; related information of rejecting or unsuccessfully reserving for the reference signal configuration; and a related information list of rejecting or unsuccessfully reserving for the reference signal configuration.

According to the method performed by the sixth node in a communication system according to the present disclosure, wherein the requested reserved reference signal configuration related information includes at least one reference signal configuration and validity area related information corresponding to the reference signal configuration.

According to the method performed by the sixth node in a communication system according to the present disclosure, wherein the related information included in the third response information includes at least one of: a reference signal configuration identification list; and validity area related information.

According to the method performed by the sixth node in a communication system according to the present disclosure, wherein the method further comprises: determining reference signal configuration related information of the user equipment based on twelfth information.

According to the method performed by the sixth node in a communication system according to the present disclosure, wherein the validity area related information includes at least one of: a validity area identification; a validity area identification list; a cell related identification; a cell related identification list; a recommended or suggested cell related identification; a recommended or suggested cell related identification list; and a number of reference signal configuration or reference signal pre-configuration.

According to the method performed by the sixth node in a communication system according to the present disclosure, wherein the user equipment identification related information comprises at least one of: an inactive radio network temporary identification (I-RNTI); a connected radio network temporary identification (C-RNTI); and user equipment first identification.

According to another aspect of the present disclosure, there is provided a method performed by a second node in a communication system, the method comprising: receiving second request information from a sixth node, wherein the second request information is used for requesting information related to a reference signal configuration of a user equipment; sending second response information to the sixth node, wherein the second response information includes reference signal configuration information; and receiving reference signal configuration activation related information from the sixth node; wherein the reference signal configuration information includes: at least one reference signal configuration and validity area related information corresponding to the reference signal configuration; and user equipment identification related information; wherein the reference signal configuration activation related information includes: at least one reference signal configuration identification or a validity area identification corresponding to the reference signal configuration; and an activation indication.

According to the method performed by the second node in a communication system according to the present disclosure, wherein the method further comprises: sending second request information to a fourth node, wherein the second request information is used for requesting the information related to the reference signal configuration of the user equipment; and receiving second response information from the fourth node, wherein the second response information includes the reference signal configuration information; wherein the reference signal configuration information includes: at least one reference signal configuration and validity area related information corresponding to the reference signal configuration; and user equipment identification related information.

According to the method performed by the second node in a communication system according to the present disclosure, wherein the method further comprises: receiving fifth information from the sixth node, wherein the fifth information includes validity area related information; and generating first updated validity area related information based on the validity area related information.

According to the method performed by the second node in a communication system according to the present disclosure, wherein the second request information further includes the first updated validity area related information, and/or wherein the second response information further includes second updated validity area related information, wherein the second updated validity area related information is generated based on the first updated validity area related information.

According to the method performed by the second node in a communication system according to the present disclosure, wherein the method further comprises: sending first request information to a fourth node, wherein the first request information is used for requesting information related to available reference signal resources; and receiving first response information from the fourth node, wherein the first request information includes at least one of the following: a reference signal resource request; a reference signal resource time window request; a cell related identification; and a first cell related identification list; wherein the first response information includes at least one of: a cell related identification; a second cell related identification list; reference signal resource related information; a reference signal resource related information list; time window related information; and a time window related information list.

According to the method performed by the second node in a communication system according to the present disclosure, wherein the method further comprises: transmitting fourteenth information to the user equipment, wherein the fourteenth information includes the reference signal configuration related information of the user equipment.

According to another aspect of the present disclosure, there is provided a method performed by a third node in a communication system, the method comprising: sending third request information to a fifth node, wherein the third request information is used for requesting information related to reserved reference signal configuration; and receiving third response information from the fifth node; wherein the third request information includes at least one of the following: a reference signal configuration reservation request; requested reserved reference signal configuration related information; and user equipment identification related information; wherein the third response information includes at least one of: an indication of accepting or rejecting to reserve for the reference signal configuration; related information of accepting or successfully reserving for the reference signal configuration; and related information of rejecting or unsuccessfully reserving for the reference signal configuration.

According to another aspect of the present disclosure, there is provided a method performed by a sixth node in a communication system, the method comprising: transmitting sixteenth information to a second node, wherein the sixteenth information includes information related to reference signal configuration or pre-configuration activation; and receiving a response message related to reference signal configuration or pre-configuration activation from a second node; wherein, the information related to the reference signal configuration or pre-configuration activation includes at least one of the following: a reference signal configuration identification; a validity area identification; and validity area related information.

According to the method performed by the sixth node in a communication system according to the present disclosure, the method further comprises sending seventeenth information to a third node, wherein the seventeenth information comprises a message related to reference signal configuration or preconfigured deactivation.

According to the method performed by the sixth node in a communication system according to the present disclosure, the method further comprises transmitting nineteenth information to a second node, wherein the nineteenth information includes information related to a reference signal measurement or pre-measurement.

According to the method performed by the sixth node in a communication system according to the present disclosure, the method further comprises receiving fifteenth information from a second node or a third node, wherein the fifteenth message includes information related to reference signal configuration or pre-configuration.

According to the method performed by the sixth node in a communication system according to the present disclosure, wherein the fifteenth information or the seventeenth information or the nineteenth information includes at least one of: a reference signal configuration identification; a validity area identification; a validity area; and a reference signal request or indication.

According to another aspect of the present disclosure, there is provided a method performed by a second node in a communication system, the method comprising: transmitting sixteenth information to a fourth node, wherein the sixteenth information includes information related to reference signal configuration or pre-configuration activation; and receiving a response message related to reference signal configuration or pre-configuration activation from the fourth node; wherein, the information related to the reference signal configuration or pre-configuration activation includes at least one of the following: a reference signal configuration identification; a validity area identification; and a validity area related information.

According to the method performed by the second node in a communication system according to the present disclosure, the method further comprises receiving a retrieve user equipment context response message from a third node, wherein the retrieve user equipment context response message includes a user equipment first identification.

According to the method performed by the second node in a communication system according to the present disclosure, the method further comprises transmitting nineteenth information to a fourth node, wherein the nineteenth information includes information related to a reference signal measurement or pre-measurement.

According to the method performed by the second node in a communication system according to the present disclosure, the method further comprises transmitting eighteenth information to user equipment, wherein the eighteenth information comprises a message related to reference signal transmission activation, wherein the message related to reference signal transmission activation comprises at least one of: a transmission activation request; reference signal configuration identification; a validity area identification; and a validity area.

According to another aspect of the present disclosure, there is provided a method performed by a third node in a communication system, the method comprising: receiving a retrieve user equipment context request message from a second node; and sending a retrieve user equipment context response message to the second node, wherein the retrieve user equipment context response message includes a user equipment first identification.

According to the method performed by the third node in a communication system according to the present disclosure: sending fifteenth information to a sixth node, wherein the fifteenth message includes a message related to reference signal configuration or pre-configuration; wherein, the message related to reference signal configuration or pre-configuration includes at least one of the following: a reference signal configuration identification; a validity area identification; a validity area; and a reference signal request or indication.

According to the method performed by the third node in a communication system according to the present disclosure, the method further comprises sending seventeenth information to a fifth node, wherein the seventeenth information comprises a message related to the deactivation of reference signal configuration or pre-configuration; wherein, the message related to reference signal configuration or pre-configuration deactivation includes at least one of the following: a reference signal configuration identification; and a validity area identification.

According to another aspect of the present disclosure, there is provided a method performed by a user equipment in a communication system, the method comprising: receiving fourteenth information from a second node, wherein the fourteenth information includes the reference signal configuration related information of the user equipment, and transmitting a reference signal in a validity area of the user equipment based on the reference signal configuration related information of the user equipment; wherein, the reference signal configuration related information of the user equipment includes at least one of the following: reference signal configuration information; and reference signal configuration activation related information.

According to the method performed by the user equipment in a communication system according to the present disclosure, wherein the reference signal configuration activation related information includes at least one of: a reference signal configuration identification; reference signal configuration; a validity area identification; a validity area; and an activation indication.

According to another aspect of the present disclosure, there is provided a method performed by user equipment in a communication system, the method comprising: sending a radio resource control resume request message to a second node, wherein the radio resource control resume request message includes an inactive radio network temporary identification (I-RNTI) and a reference signal request or indication; and receiving eighteenth information from the second node, wherein the eighteenth information includes at least one of: a transmission activation request; reference signal configuration identification; a validity area identification; and a validity area.

According to another aspect of the present disclosure, there is provided a sixth node device including a transceiver configured to transmit and receive signals with the outside; and a controller configured to control the transceiver to perform the method performed by the sixth node device.

According to another aspect of the present disclosure, there is provided a second node device including a transceiver configured to transmit and receive signals with the outside; and a controller configured to control the transceiver to perform the method performed by the second node device.

According to another aspect of the present disclosure, there is provided a third node device including a transceiver configured to transmit and receive signals with the outside; and a controller configured to control the transceiver to perform the method performed by the third node device.

According to another aspect of the present disclosure, there is provided a user equipment including a transceiver configured to transmit and receive signals with the outside; and a controller configured to control the transceiver to perform the method performed by the user equipment.

According to another aspect of the present disclosure, there is provided a non-transitory computer-readable recording medium having stored thereon a program which, when being executed by a computer, performs any of the above methods.

Those skilled in the art will understand that the illustrative embodiments described above are described herein and are not intended to be limiting. It should be understood that any two or more of the embodiments disclosed herein can be combined in any combination. In addition, other embodiments can be utilized and other changes can be made without departing from the spirit and scope of the subject matter presented herein. It will be readily understood that aspects of the present invention of the present disclosure, as generally described herein and shown in the accompanying drawings, can be arranged, substituted, combined, separated and designed in various different configurations, all of which are contemplated herein.

Those skilled in the art will understand that the various illustrative logical blocks, modules, circuits, and steps described in the present application can be implemented as hardware, software, or a combination of both. In order to clearly illustrate this interchangeability between hardware and software, various illustrative components, blocks, modules, circuits, and steps are generally described above in the form of their function set. Whether such a function set is implemented as hardware or software depends on the specific application and the design constraints imposed on the total/overall system. Skilled people can implement the described function set in different ways for each specific application, but such design decisions should not be interpreted as causing a departure from the scope of the present application.

The various illustrative logic blocks, modules, and circuits described in the present application can be implemented in a general-purpose processor, a Digital Signal Processor (DSP), an Application Specific Integrated Circuit (ASIC), a Field Programmable Gate Array (FPGA) or other programmable logic devices, discrete gate or transistor logic, discrete hardware component, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of the method or technique described in the present application can be embodied directly in hardware, in a software module executed by a processor, or in a combination of both. Software modules may reside in RAM memory, flash memory, ROM memory, EPROM memory, EEPROM memory, register, hard disk, removable disk, or any other form of storage media known in the art. An example storage medium is coupled to a processor to enable the processor to read and write information from/to the storage medium. In the alternative, the storage medium may be integrated into the processor. The processor and storage medium may reside in an ASIC. The ASIC may reside in the UE. In the alternative, the processor and the storage medium may reside in the UE as discrete components.

In one or more designs, the described functions can be implemented in hardware, software, firmware, or any combination thereof. If implemented in software, each function can be stored on or transferred by a computer-readable medium as one or more instructions or codes. Computer-readable media include both computer storage media and communication media, which includes any media that facilitates the transfer of computer programs from one place to another. The storage medium may be any available medium that can be accessed by a general-purpose or special-purpose computer.

What has been described above is only an embodiment of the present disclosure, and is not used to limit the protection scope of the present disclosure, which is determined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a location management function (LMF) entity in a communication system, the method comprising:
transmitting, to a serving base station, a first request message for an area-specific reference signal configuration; and
receiving, from the serving base station, a first response message including reference signal configuration information,
wherein the reference signal configuration information includes at least one reference signal configuration and validity area related information corresponding to the reference signal configuration.

2. The method of claim 1, wherein the first request message includes at least one of:
an area specific reference signal configuration request,
a reference signal pre-configuration request,
second validity area related information, and
a user equipment first identification.

3. The method of claim 1, further comprising:
transmitting, to the serving base station, a second request message for information related to available reference signal resources; and
receiving, from the serving base station, a second response message,
wherein the second request message includes at least one of:
a reference signal resource request,
a reference signal resource time window request,
a cell related identification, and
a first cell related identification list, and
wherein the second response message includes at least one of:
a cell related identification,
a second cell related identification list,
reference signal resource related information,
a reference signal resource related information list,
time window related information, and
a time window related information list.

4. The method of claim 3, wherein the reference signal resource related information includes at least one of:
overall resources of a reference signal,
available reference signal resources or unused reference signal resources, and
used reference signal resources or a configured reference signal configuration.

5. The method of claim 1, further comprising:
transmitting, to a neighboring base station, a third request message for information related to reserved reference signal configuration; and
receiving, from the neighboring base station, a third response message,
wherein the third request message includes at least one of:
a reference signal configuration reservation request,
requested reserved reference signal configuration related information, and
user equipment identification related information, and
wherein the third response message includes at least one of:
an indication of accepting or rejecting to reserve for the reference signal configuration,
an indication of successful or unsuccessful reservation of the reference signal configuration,
related information of accepting or successfully reserving for the reference signal configuration,
a related information list of accepting or successfully reserving for the reference signal configuration,
related information of rejecting or unsuccessfully reserving for the reference signal configuration, and
a related information list of rejecting or unsuccessfully reserving for the reference signal configuration.

6. The method of claim 5, wherein the requested reserved reference signal configuration related information includes at least one reference signal configuration and validity area related information corresponding to the reference signal configuration.

7. The method of claim 5, wherein the related information included in the third response message includes at least one of a reference signal configuration identification list and validity area related information.

8. The method of claim 1, wherein the validity area related information includes at least one of:
a validity area identification,
a validity area identification list,
a cell related identification,
a cell related identification list including a physical cell identification list and a cell global identification list,
a recommended or suggested cell related identification,
a recommended or suggested cell related identification list, and
a number of reference signal configuration or reference signal pre-configuration.

9. The method of claim 2, wherein the second validity area related information includes at least one of:
a validity area identification,
a validity area identification list,
a cell related identification,
a cell related identification list including a physical cell identification list and a cell global identification list,
a recommended or suggested cell related identification,
a recommended or suggested cell related identification list, and
a number of reference signal configuration or reference signal pre-configuration.

10. The method of claim 1, wherein the reference signal configuration information further includes user equipment identification related information, which includes at least one of:
an inactive radio network temporary identification (I-RNTI),
a connected radio network temporary identification (C-RNTI), and
a user equipment first identification.

11. A method performed by a serving base station in a communication system, the method comprising:
receiving, from a location management function (LMF) entity, a first request message for an area-specific reference signal configuration; and
transmitting, to the LMF entity, a first response message including reference signal configuration information,
wherein the reference signal configuration information includes at least one reference signal configuration and validity area related information corresponding to the reference signal configuration.

12. The method of claim 11, further comprising:
transmitting, to a distribution unit of the serving base station, a second request message for an area-specific reference signal configuration; and
receiving, from the distribution unit of the serving base station, a second response message including the reference signal configuration information,
wherein the reference signal configuration information includes:
at least one reference signal configuration and validity area related information corresponding to the reference signal configuration, and
user equipment identification related information.

13. The method of claim 11, further comprising:
receiving, from the LMF entity, first information including validity area related information; and
generating first updated validity area related information based on the validity area related information.

14. The method of claim 13, wherein the first request message further includes the first updated validity area related information, or
wherein the first response message further includes second updated validity area related information, wherein the second updated validity area related information is generated based on the first updated validity area related information.

15. The method of claim 11, further comprising:
transmitting, to a distribution unit of the serving base station, a third request message for information related to available reference signal resources; and
receiving, from the distribution unit of the serving base station, a third response message,
wherein the second request message includes at least one of:
a reference signal resource request,
a reference signal resource time window request,
a cell related identification, and
a first cell related identification list,
wherein the second response message includes at least one of:
a cell related identification,
a second cell related identification list,
reference signal resource related information,
a reference signal resource related information list,
time window related information, and
a time window related information list.

16. The method of claim 11, further comprising:
transmitting, to the user equipment (UE), second information including the reference signal configuration information of the UE.

17. A location management function (LMF) entity in a communication system, the LMF entity comprising:
a transceiver; and
at least one processor coupled to the transceiver and configured to:
transmit, to a serving base station, a first request message for an area-specific reference signal configuration, and
receive, from the serving base station, a first response message including reference signal configuration information,
wherein the reference signal configuration information includes at least one reference signal configuration and validity area related information corresponding to the reference signal configuration.

18. The LMF entity of claim 17, wherein the at least one processor is further configured to:
transmit, to the serving base station, a second request message for information related to available reference signal resources, and
receive, from the serving base station, a second response message,
wherein the second request message includes at least one of:
a reference signal resource request,
a reference signal resource time window request,
a cell related identification, and
a first cell related identification list, and
wherein the second response message includes at least one of:
a cell related identification,
a second cell related identification list,
reference signal resource related information,
a reference signal resource related information list,
time window related information, and
a time window related information list.

19. A serving base station in a communication system, the serving base station comprising:
a transceiver; and
at least one processor coupled to the transceiver and configured to:
receive, from a location management function (LMF) entity, a first request message for an area-specific reference signal configuration, and
transmit, to the LMF entity, a first response message including reference signal configuration information,
wherein the reference signal configuration information includes at least one reference signal configuration and validity area related information corresponding to the reference signal configuration.

20. The serving base station of claim 19, wherein the at least one processor is further configured to:
transmit, to a distribution unit of the serving base station, a second request message for an area-specific reference signal configuration, and
receive, from the distribution unit of the serving base station, a second response message including the reference signal configuration information,
wherein the reference signal configuration information includes:
at least one reference signal configuration and validity area related information corresponding to the reference signal configuration, and
user equipment identification related information.
